(19) United States
(12) Patent Application Publication
(10) Pub. No.: US 2005/0093444 A1
(43) Pub. Date: May 5, 2005

(54) Plasma display panel

(76) Inventors: Seok-Gyun Woo, Asan-si (KR); Kyoung-Doo Kang, Seoul (KR); Won-Ju Yi, Cheonan-si (KR)

Correspondence Address: Robert E. Bushnell, Suite 300, 1522 K Street, N.W., Washington, DC, 20005-1202, US

(21) Appl. No.: 10/834,047

(22) Filed: Apr. 29, 2004

(30) Foreign Application Priority Data
Oct. 29, 2003 (KR) 2003-76096

(51) Int. Cl. H01J 17/49

(52) U.S. Cl. 313/582

(57) ABSTRACT

A plasma display panel includes a pair of substrates spaced apart from each other and facing each other, a visible light generator arranged between the pair of substrates, and an electrode layer adapted to apply the same potential to a plane arranged between the pair of substrates at a predetermined angle with respect to a direction perpendicular to the pair of substrates.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on Oct. 29, 2003 and there duly assigned Ser. No. 2003-76096.

### BACKGROUND OF THE INVENTION

1. Field of the Invention

The present invention relates to a plasma display panel (PDP) adapted to display a character or an image using a gas discharge phenomenon, and more particularly, to a PDP having an increased surface on which a discharge is generated.

2. Description of the Related Art

In recent years, PDPs have attracted considerable attention as the most promising next generation of flat display devices, because they have various advantageous features including a high image quality display, a very thin and lightweight design, and a wide-range viewing angle with a large screen, and they can be manufactured in a simplified manner and can be easily manufactured in a large size.

Such a PDP is roughly classified into a DC type, an AC type and a hybrid type according to the driving voltage applied to a discharge cell. Also, a PDP is classified into an opposite discharge type and a surface discharge type according to the arrangement of the electrodes.

In a DC type PDP, all of the electrodes are exposed to a discharge space and thus a migration of charges occurs directly between the corresponding electrodes. On the other hand, in an AC type PDP, at least one electrode is covered by a dielectric layer, and there is no direct migration of charges between the corresponding electrodes. Instead, a discharge is effected by an electric field of wall charges.

In the DC type PDP, since electric charges are directly moved between the corresponding electrodes, the electrodes can be severely damaged. To overcome this shortcoming, AC type PDPs, specifically, three-electrode surface discharge type PDPs have been in widespread use recently.

### SUMMARY OF THE INVENTION

For solving the above-described problems and other limitations of the related art, the present invention is directed to a plasma display panel (PDP) having a novel structure.

The present invention provides a PDP having an increased aperture percentage and enhanced transmissivity, which cannot be achieved by the conventional PDP.

The present invention also provides a PDP having a considerably increased discharge area by increasing a discharge surface.

The present invention also provides a PDP that can effectively utilize space charges of the plasma by concentrating the plasma on a predetermined portion, e.g., a center, of a discharge

The present invention also provides a PDP having an improved luminous efficiency.

The present invention also provides a PDP having a reduced permanent latent image phenomenon.

The present invention provides a PDP having a relatively low driving voltage.

Furthermore, the present invention provides a PDP having a fast discharge response speed and a high-speed drive.

In accordance with an aspect of the present invention, there is provided a plasma display panel comprising a pair of substrates spaced apart from each other and facing each other, a phosphor arranged between the pair of substrates in a predetermined pattern, and an electrode layer adapted to apply the same potential on a plane arranged between the pair of substrates at a predetermined angle with respect to a direction perpendicular to the pair of substrates.

The electrode layer can include an internal space where a discharge occurs. The electrode layer can be annular. The electrode layer can enclose the discharge spaces.

The electrode layer can be arranged on a surface in a direction perpendicular to the pair of substrates.

The plasma display panel can further comprise another electrode layer spaced a predetermined distance apart from the electrode layer.

In accordance with another aspect of the present invention, there is provided a plasma display panel comprising a pair of substrates having a plurality of discharge spaces between facing surfaces thereof, a phosphor formed between the pair of substrates in a predetermined pattern, one or more electrodes arranged on a plane having a predetermined angle with respect to a direction perpendicular to the pair of substrates, the one or more discharge sustaining electrodes adapted to sustain a discharge by applying an AC voltage thereto, and an electrode adapted to initiate a discharge in response to a voltage being applied thereto and to one of the discharge sustaining electrodes.

The electrode layer can include an internal space where a discharge occurs. The electrode layer can be annular. The electrode layer can enclose the discharge spaces.

In accordance with still another aspect of the present invention, there is provided a plasma display panel comprising a pair of substrates having a plurality of discharge spaces between facing surfaces thereof, and at least one electrode adapted to sustain a discharge on surfaces forming the discharge spaces, excluding the facing surfaces of the pair of substrates, by applying an AC voltage thereto, the at least one electrode enclosing the discharge spaces.

The electrode can be arranged between the pair of substrates.

The electrode can be arranged perpendicular to the pair of substrates.

The electrode can be arranged at an angle with respect to the pair of substrates.

The electrode can be arranged parallel to the pair of substrates.

The electrode can extend from the pair of substrates toward the central portion of the discharge space.

According to still another aspect of the present invention, there is provided a plasma display panel comprising a pair of substrates spaced apart from and facing each other, a side wall dividing a space between the pair of substrates into a plurality of discharge spaces, and at least one electrode adapted to sustain a discharge on surfaces forming the discharge spaces, excluding the facing surfaces of the pair of substrates, by applying an AC voltage thereto.

The electrode can be arranged on the side wall. The electrode can be arranged substantially parallel to the side wall. The electrode can be arranged at an angle with respect to the pair of substrates. The electrode layer can enclose the discharge spaces.

According to still another aspect of the present invention, there is provided a plasma display panel comprising a pair of substrates having a plurality of discharge spaces between facing surfaces thereof, and at least two electrodes adapted to sustain a discharge by applying an AC voltage thereto, the at least two electrodes located within the discharge surface and arranged on two different surfaces meeting an axis perpendicular to the pair of substrates.

The at least two electrodes can be perpendicular to the pair of substrates. Also, the at least two electrodes can be arranged at an angle with respect to the pair of substrates.

According to another aspect of the present invention, there is provided a plasma display panel comprising a surface adapted to sustain a discharge on a plurality of discharge spaces formed between a pair of substrates spaced apart from and facing each other, the surface being at an angle with respect to the pair of substrates.

The surface where a discharge is induced can be a lateral surface of the discharge space.

The surface where a discharge is induced can be perpendicular to the pair of substrates.

The surface where discharge is induced can be arranged at an angle with respect to the pair of substrates. The electrode layer can enclose the discharge spaces.

The surface where a discharge is induced can be parallel to the pair of substrates.

The surface where a discharge is induced can be a ring shaped element surrounding an axis perpendicular to the pair of substrates.

In another aspect of the present invention, there is provided a plasma display panel comprising a pair of substrates spaced a predetermined distance apart from and facing each other, a side wall dividing a space between the pair of substrates into a plurality of discharge spaces, at least one electrode arranged on the side wall and adapted to sustain a discharge by applying an AC voltage thereto, and a phosphor adapted to generate visible light in the discharge space. The at least one electrode can enclose the discharge spaces.

In another aspect of the present invention, the present invention provides a plasma display panel comprising a pair of substrates having a plurality of discharge spaces between facing surfaces thereof, a side wall dividing a space between the pair of substrates into a plurality of discharge spaces, one or more discharge sustaining electrodes arranged on the side wall and adapted to sustain a discharge, and at least one address electrode adapted to initiate a discharge in response to a voltage applied thereto and to one of the discharge sustaining electrodes.

The at least one address electrode can be arranged on either of the pair of substrates.

The plasma display panel can further include a phosphor arranged on the substrate where the at least one address electrode is not arranged, and adapted to generate visible light in the discharge space.

The at least one address electrode can be arranged on the side wall.

In still another aspect, the present invention provides a flat display panel comprising the plasma display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial perspective view of a conventional PDP;

FIG. 2A is a partial perspective view of a PDP according to an embodiment of the present invention;

FIG. 2B is a partially enlarged view of a portion “A” shown in FIG. 2A;

FIG. 3A is a cross-sectional view illustrating a discharge space oft he PDP shown in FIG. 2, taken along the line 3a-3a;

FIG. 3B is a cross-sectional view of FIG. 3A, taken along the line 3b-3b;

FIG. 4A is a cross-sectional view illustrating another example of a discharge electrode shown in FIG. 3A;

FIG. 4B is a cross-sectional view of FIG. 4A, taken along the line 4b-4b;

FIG. 5A is a cross-sectional view illustrating still another example of a discharge electrode shown in FIG. 3A;

FIG. 5B is a cross-sectional view of FIG. 45, taken along the line 5b-5b;

FIG. 6 is a plan view illustrating a connection state of a discharge electrode shown in FIG. 2;

FIGS. 7A through 7F are cross-sectional views illustrating a procedure in which a discharge occurs in the discharge space shown in FIG. 2;

FIGS. 8A and 8B are cross-sectional views illustrating a discharge space of a PDP according to another embodiment of the present invention;

FIG. 9 is a partial plan view illustrating an arrangement of discharge electrodes shown in FIGS. 8A and 8B;

FIG. 10A is a cross-sectional view partially illustrating a PDP according to another embodiment of the present invention;

FIG. 10B is a cross-sectional view of FIG. 10A, taken along the line 10b-10b; and

FIG. 11 is a cross-sectional view illustrating a discharge space of a PDP according to another embodiment of the present invention.

### DETAILED DESCRIPTION OF THE INVENTION

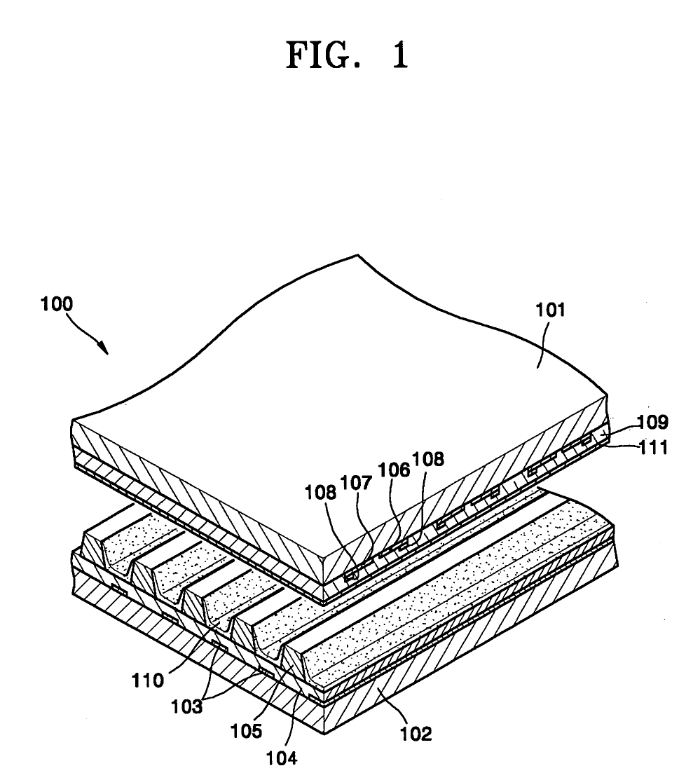

A conventional surface discharge PDP 100, including an AC type three-electrode surface discharge PDP, as shown in FIG. 1, includes a front substrate 101 through which visible lights emitted from a phosphor 110 in a discharge space, X and Y electrodes 107 and 108 are adapted to cause a discharge, bus electrodes 108, and a dielectric layer 109 and a protective layer sequentially formed thereon, are all provided on the front substrate 101, thereby lowering the transmissivity of visible light to approximately 60%. Also, in the conventional surface discharge PDP 100, discharge electrodes are formed on top of a discharge space, that is, on an internal surface of the front substrate 101 through which visible light passes, and discharge occurs on the internal surface to cause visible light to be dispersed, thereby lowering luminous efficiency. Also, if the conventional PDP 100 is used for an extended period of time, charge particles in a discharge gas can cause ion sputtering to the phosphors due to an electric field, thereby resulting in a permanent latent image.

Various embodiments of the present invention will be explained below in detail with reference to the drawings. These embodiments and drawings are provided for better understanding of the present invention and the invention is not limited thereto. Rather, the scope of the invention shall be determined by the appended claims.

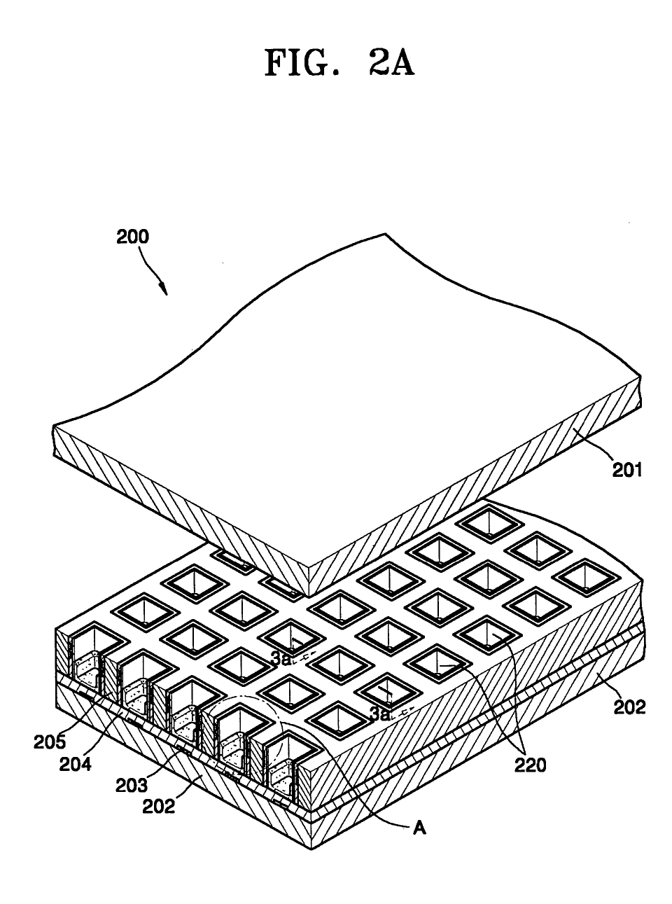

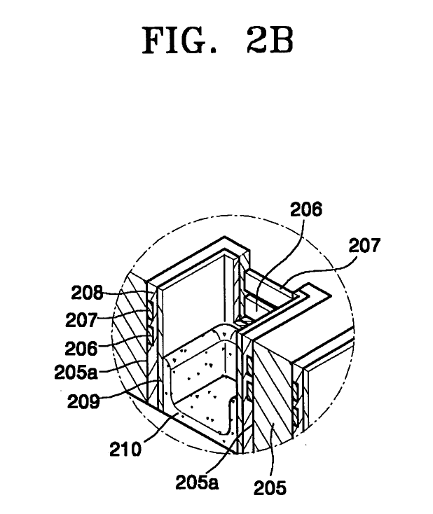

Referring to FIGS. 2 through 7F, a plasma display panel 200 according to a first embodiment of the present invention will be described.

Hereinbelow, the terms and description used herein are set forth by way of illustration only and are not meant as limitations. Those skilled in the art will recognize that numerous variations are possible within the spirit and scope of the invention as defined in the appended claims.

A PDP 200 according to the first embodiment, as shown in FIGS. 2A and 2B, has a pair of substrates, e.g., a front substrate 201 and a rear substrate 202, spaced apart to and facing each other. Partitions 205 for partitioning a plurality of discharge spaces 220 are arranged between the front substrate 201 and the rear substrate 202 in a predetermined pattern. The partitions 205 can have various patterns as long as the plurality of discharge spaces 220 can be formed, including open-type partitions 205 such as stripes, or closed-type partitions 205 such as waffles, matrices or deltas. The closed-type partitions can be formed such that a horizontal cross-section of each of the discharge spaces 220 is polygonal, such as triangular or pentagonal as well as rectangular as in the illustrative embodiment, or circular or elliptical. The partitions 205 serve to form discharge electrodes 206 and 207 as well as to form the discharge spaces 220. The partitions 205 can be formed in any type as long as the discharge electrodes 206 and 207 can be installed so as to initiate a discharge and to extend discharge sections. For example, the partitions 205 can be formed such that lateral surfaces 205a thereof extend perpendicular to the front substrate 201 or obliquely in either direction of the perpendicular direction. Also, some of the lateral surfaces 205a extend obliquely in one direction and others extend obliquely in the other direction. As described above, the partitions 205 are constructed in various manners, so that the discharge electrodes 206 and 207 can be arranged in various shapes and patterns on the lateral surfaces 205a of the partitions 205. Accordingly, a discharge corresponding to various discharge sections can be initiated or extended in various manners. Address electrodes 203 are formed on the rear substrate 202 in a predetermined pattern, e.g., a stripe pattern, to correspond to the respective discharge spaces 220 so that a voltage for selecting a discharge space at which a discharge is initiated is applied thereto. The pattern of the address electrodes 203 is not limited to the stripe pattern and a variety of patterns can be used according to the shape of the discharge space 220. The address electrodes 203 can be arranged on any other appropriate location, e.g., the front substrate 201 or the partitions 205. According to another feature of the present invention, forming of the address electrodes 203 can be skipped because the voltage for selecting a discharge space at which a discharge is initiated can be applied between the discharge electrodes 206 and 207 through appropriate arrangement of the discharge electrodes 206 and 207, for example, by arranging the discharge electrodes 206 and 207 to be orthogonal to each other.

A rear dielectric layer 204 is formed on the rear substrate 202 to cover the address electrodes 220. Although formation of the rear dielectric layer 204 is shown in the illustrative embodiment, the rear dielectric layer 204 is not an essential component of the present invention. Also, in the illustrative embodiment, the partitions 205 are installed on the rear dielectric layer 204, but the present invention is not limited to this. For example, once the partitions 205 are installed on the rear substrate 202, the address electrodes 220 and the rear dielectric layer 204 can be sequentially arranged on the rear substrate 202 between each of the partitions 205.

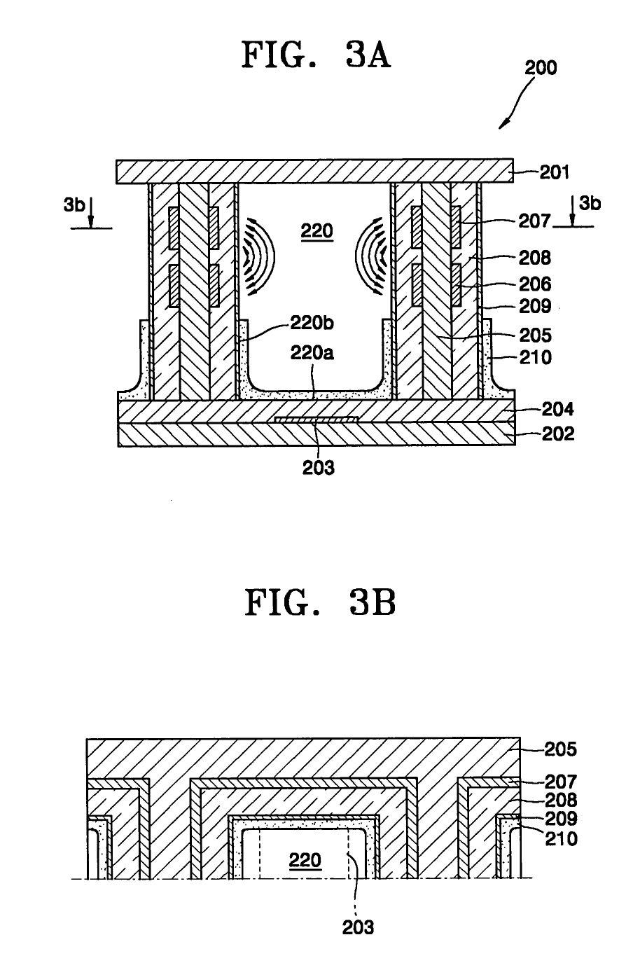

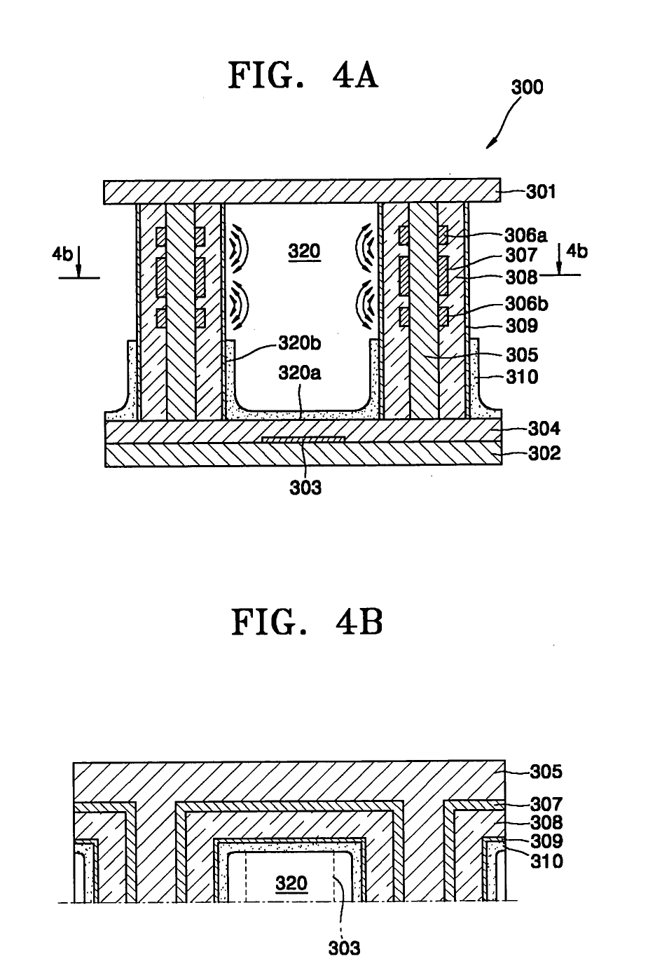

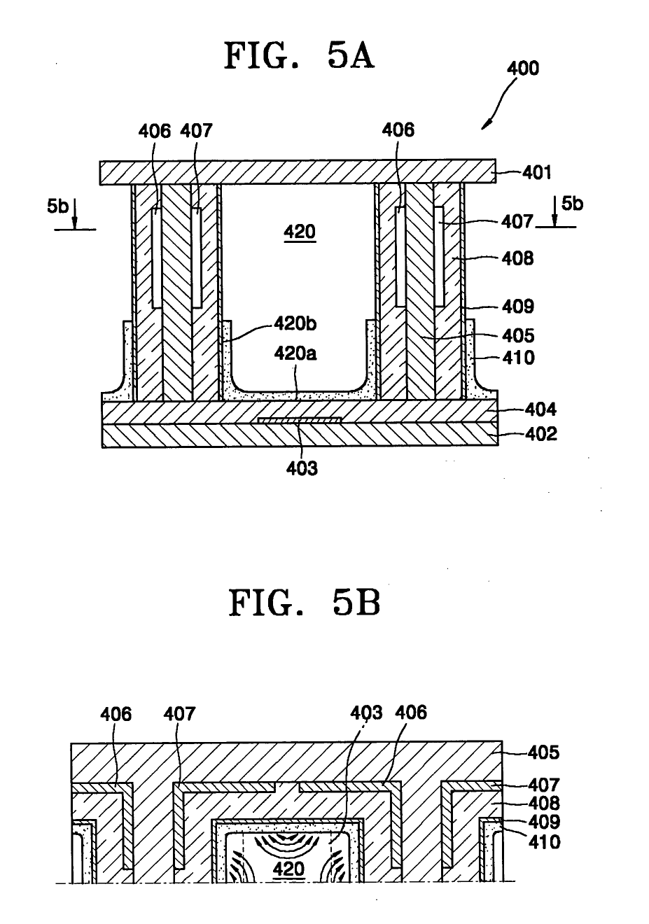

As shown in FIG. 3A, electrodes adapted to cause a discharge in the discharge space 220, that is, X electrode 207 and Y electrode 206, are formed on the partitions 205. The X electrode 207 and the Y electrode 206 are arranged such that a discharge due to an AC voltage applied between the two electrodes can be sustained on a surface at which the two electrodes 207 and 206 are connected to each other. In the illustrative embodiment, the X and Y electrodes 207 and 206 are formed on the partitions 205, but the invention is not limited thereto. For example, as shown in FIGS. 3A and 3B, the X and Y electrodes 207 and 206 can be formed along the periphery of the partition 205 in a ring shape in parallel with each other. A distance between the X electrode 207 and the Y electrode 206 spaced apart from each other is set to be enough to sustain the discharge due to the applied AC voltage. It is preferable that the distance between the two electrodes 207 and 206 is shortened, allowing a low voltage drive. Although in the illustrative embodiment, the X and Y electrodes 207 and 206 have a ring shape, the present invention is not limited thereto and many shapes can be employed. As to arrangement, the X and Y electrodes 207 and 206 can be arranged in various manners, and an arrangement in which a discharge is easily initiated and extended with a low voltage is preferred. For example, in order to allow as wide a discharge surface as possible, a ring-shaped X electrode 307 and ring-shaped Y electrodes 306a and 306b are arranged such that the Y electrodes 306a and 306b are arranged at opposite sides of the X electrode 307, as shown in FIGS. 4A and 4B, or vice versa. If the X electrode 307 and Y electrodes 306a and 306b are arranged in such a manner, as shown by arrows in FIG. 4A, an effect of increasing a discharge surface in a height direction of a discharge space 320 can be exerted. In this case, in order to reduce an address voltage applied between an address electrode 303 and the Y electrode 306b, the Y electrode 306b can be arranged to be close to the address electrode 303, that is, the Y electrode 306b is arranged to be close to a rear substrate 302. Alternatively, as shown in FIGS. 5A and 5B, an X electrode 407 and a Y electrode 406 can be arranged such that facing sides thereof are perpendicular to a substrate, e.g., a front substrate 401, from the viewpoint of a discharge space 420. In other words, as shown in FIG. 5B, the X electrode 407 is arranged vertically from the viewpoint of the discharge space 420 and Y electrodes 406 are arranged at both sides of the X electrode 407 to be adjacent thereto at a predetermined interval, so that facing portions of the X electrode 407 and Y electrodes 406 are perpendicular to a front substrate 401. The respective discharge electrodes 406 and 407 are preferably symmetrically arranged across two neighboring sides. The thus-constructed discharge electrodes 406 and 407 brings about an effect of extending a discharge surface toward the periphery of a discharge space 420, as shown in FIG. 5B. In addition, the discharge electrodes 406 and 407 can have various shapes and arrangement types.

Referring back to FIGS. 3A and 3B, the X electrode 207 and Y electrodes 206 can be formed by various methods, for example, printing, sandblasting, depositing, etching or the like. The X electrode 207 and the Y electrodes 206 are preferably arranged above the partition 205.

In order to establish insulation between the X electrode 207 and the Y electrodes 206, a lateral dielectric layer 208 can be arranged therebetween. The lateral dielectric layer 208 can be formed on the partition 205 to cover the X and Y electrodes 207 and 206.

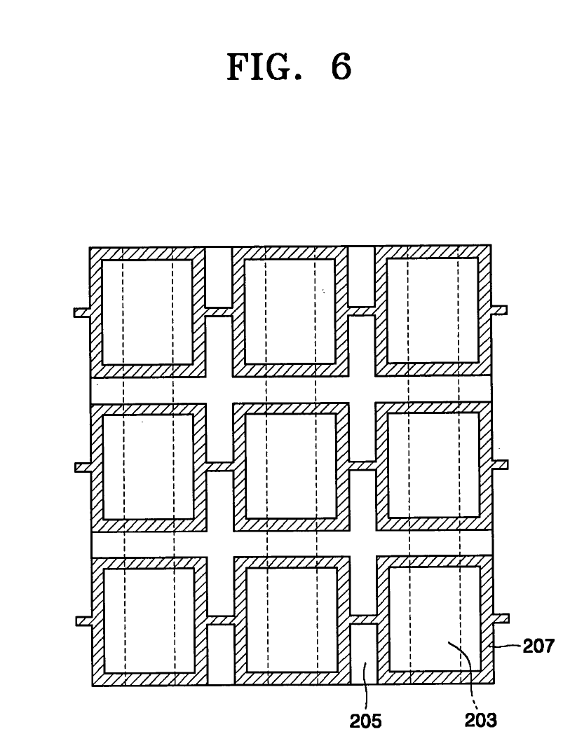

FIG. 6 shows an example in which X electrodes arranged in the respective discharge spaces 220 are connected to each other. Similarly, Y electrodes 206 arranged in the respective discharge spaces 220 can also be connected to each other.

A protective layer 209 of MgO, for protecting the lateral dielectric layer 208, can be formed on the lateral dielectric layer 208.

A fluorescent substance 210 excited by UV rays generated from a discharge gas, for emitting visible light, is formed in a discharge space 220 formed by the lateral dielectric layer 208, the rear dielectric layer 204 and the front substrate 201. The fluorescent substance 210 can be formed at any location of the discharge space 220, and can be formed at the lower portion of the discharge space 220 close to the rear substrate 202 so as to cover the bottom surface 220a of the discharge space 220 and to cover the lower portion of the side 220b, in view of transmissivity of visible light, as shown in FIG. 3A or can be formed at the upper portion of the discharge space 220 close to the front substrate 201.

A discharge gas such as Ne, Xe or a mixed gas thereof is sealed within the discharge space 220. In the present invention, including this embodiment, a discharge surface is increased and a discharge section is extended, so that an increased quantity of plasma is produced, allowing a low voltage drive. Thus, in the present invention, even when an Xe discharge gas is used in a high concentration, a low voltage drive can be used, thereby remarkably increasing the luminous efficiency. That is, the present invention overcomes a problem presented in the conventional PDP in which a high-concentration Xe discharge gas makes it extremely difficult to achieve a low voltage drive.

An upper opening portion of the discharge space 220 is hermetically sealed by the front substrate 201. Unlike in the conventional PDP, discharge electrodes made of indium tin oxide (ITO) or bus electrodes and a dielectric layer covering the electrodes do not exist in the front substrate 201. Therefore, in the present invention, including this embodiment, the aperture of the front substrate 201 can be greatly enhanced and transmissivity of visible light can be markedly increased to 90%, thereby implementing a low voltage drive and maximizing luminous efficiency. The front substrate 201 can be made of any material as long as it is transparent, e.g., glass.

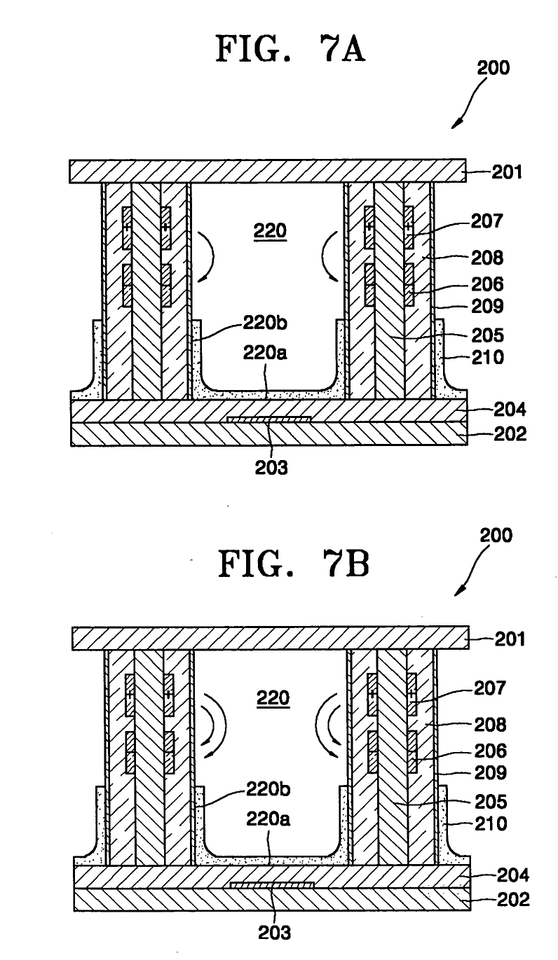

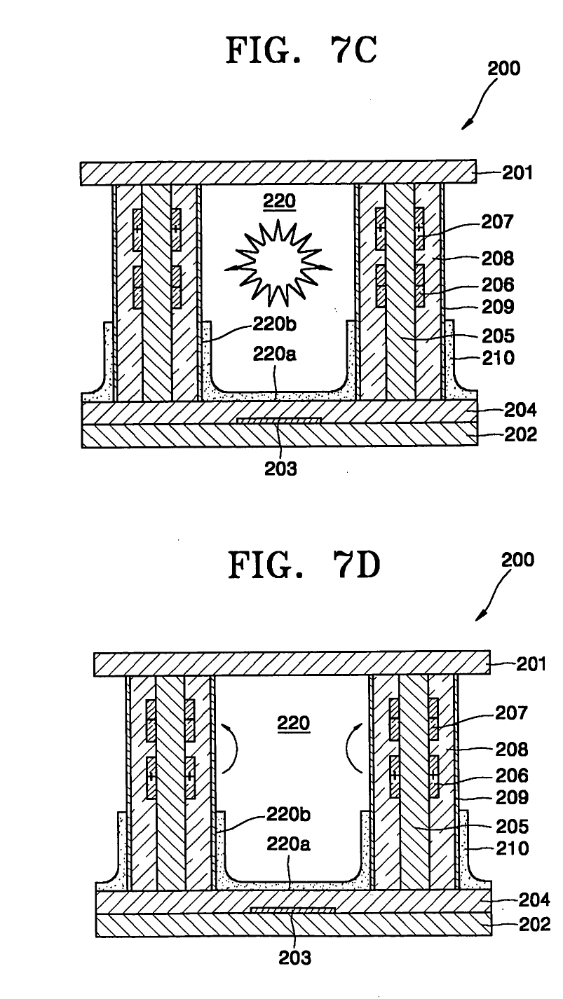

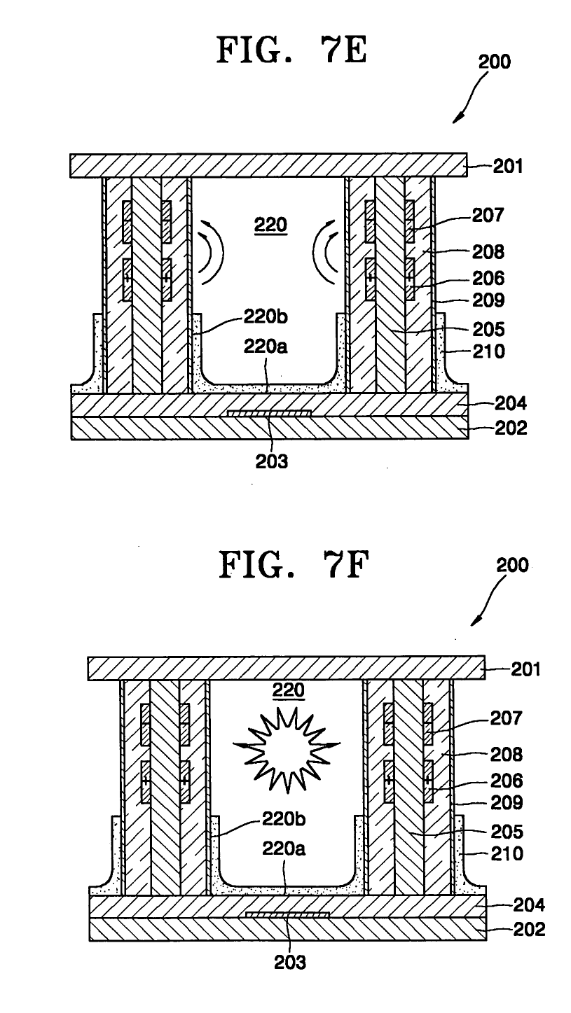

In the PDP of the illustrative embodiment, an exemplary discharge process will now be described with reference to FIGS. 7A through 7F.

If a predetermined address voltage is externally applied between the address electrode 203 and the Y electrode 206, a discharge space 220 to be lit is selected, and wall charges accumulate on the Y electrode 206 of the discharge space 220. As shown in FIG. 7A, if a positive (+) voltage is applied to the X electrode 207 and a relatively lower voltage is applied to the Y electrode 206, the wall charges migrate due to a difference in voltages applied between the X electrode 207 and the Y electrode 206. While migrating, the wall charges collide with discharge gas atoms in the discharge space 220 to induce a discharge, thereby producing plasma. A possibility of inducing the discharge is high at an area where a relatively strong electric field is generated, that is, at an area where the X electrode 207 and the Y electrode 206 are close to each other. In this embodiment, the area where the X electrode 207 and the Y electrode 206 are close to each other is formed along the lateral surface of the discharge space 220. Thus, compared to the earlier art in which an area where discharge electrodes are close to each other is formed only on the top surface of the discharge space, possibilities of inducing a discharge are greatly increased. If a difference in the voltage between two electrodes still remains sufficiently high according to passage of time, as shown in FIG. 7B, an electric field formed between surfaces of the two electrodes becomes gradually stronger, so that discharge is dispersed throughout the discharge space 220. In the illustrative embodiment, a discharge is induced at four sides of the discharge space 220 in a ring shape and are then dispersed to a central portion of the discharge space 220. By contrast, in the earlier art, a discharge is induced at a single section, that is, at the top surface of the discharge space 220 and is then dispersed to the central portion of the discharge space 220. Thus, according to this embodiment, the dispersion range of discharge is greatly increased compared to the earlier art. Also, in the illustrative embodiment, plasma generated by the discharge is formed along the lateral surface of the discharge space 220 in a ring shape and is then dispersed to the central portion of the discharge space 220, that is, the quantity of plasma generated is greatly increased, thereby increasing the amount of visible light. Also, since plasma is concentrated at the central portion of the discharge space 220, space charges can be utilized, thereby allowing a low voltage drive and increasing luminous efficiency. Further, since plasma is concentrated at the central portion of the discharge space 220 and an electric field caused by the discharge electrodes 206 and 207 is formed at either side of plasma, charges are concentrated at the central portion of the discharge space 220, thereby preventing ion sputtering toward the fluorescent substance 210. The discharge dispersed to the central portion of the discharge space 220 is terminated as shown in FIG. 7C.

Once the discharge occurs, if a difference in the voltage between the X electrode 207 and the Y electrode 206 is lower than a discharge voltage, no further discharge occurs, and space charges and wall charges are formed in the discharge space 220. At this time, polarities of voltages applied to the X electrode 207 and the Y electrode 206 are interchanged. Then, as shown in FIG. 7D, a discharge occurs again with the assistance of wall charges. Thereafter, referring to FIGS. 7E and 7F, discharge is dispersed throughout the discharge space 220 and then vanishes as shown in FIGS. 7A through 7C.

Polarities of the voltages of the X electrode 207 and the Y electrode 206 are interchanged once again, and the initial discharge process is repeated. Such repetitions cause a discharge in a stable manner.

As described above, in view of the overall discharge sustaining procedure, an AC voltage is applied between the X electrode 207 and the Y electrode 206.

In the present invention, a discharge is not limited to that discussed above, and a variety of types of discharge can be effectuated by one skilled in the art to which the present invention pertains.

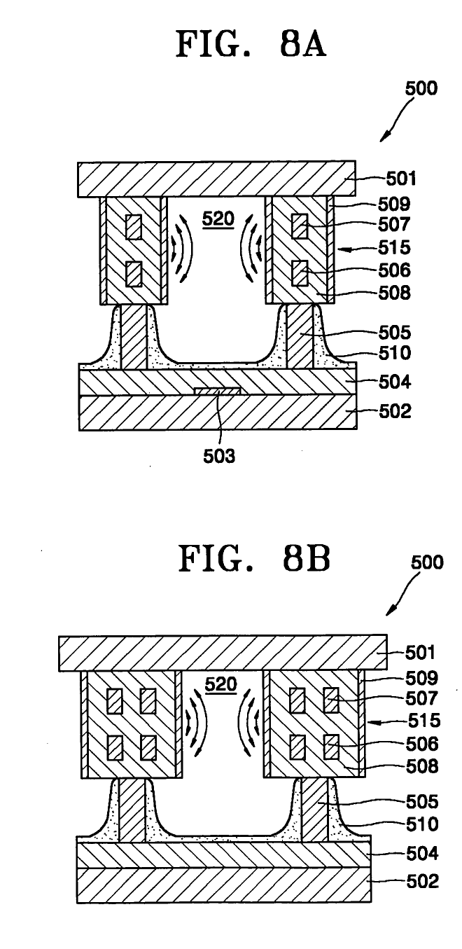

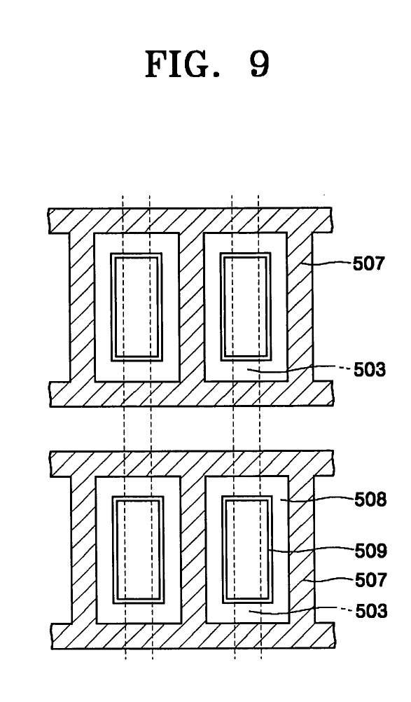

FIGS. 8A through 9 show a discharge space 520 of a PDP 500 according to a second embodiment of the present invention. Referring to FIGS. 8A and 8B, the discharge space 520 of the PDP 500 according to the second embodiment of the present invention is arranged such that discharge electrodes, that is, an X electrode 507 and a Y electrode 508, are arranged between a partition 505 and a front substrate 501 at an extending position in a height direction of the partition 505, rather than at a position of the partition 505 itself. In other words, unlike the discharge space 220 shown in the first embodiment, which is formed of only the partition 205, the discharge space 520 shown in the second embodiment is formed of the partition 505 and a side wall 515 corresponding and contiguous thereto. A fluorescent substance 510 is coated on a lateral surface of the partition 505, and a dielectric layer 508, in which the X electrode 507 and the Y electrode 506 are vertically arranged and buried, is formed within the side wall 515. A protective layer 509 is formed on an outer surface of the side wall 515. The side wall 515 can extend from the partition 505, but preferably extend from the front substrate 501 to be coupled to the partition 505. Also, in the illustrative embodiment, the X electrode 507 and the Y electrode 506 are orthogonal to an address electrode 503 formed on a rear substrate 502 and are formed in a duplicated manner, as shown in FIG. 8B. FIG. 9 shows an arrangement state of the Y electrode 506.

In the PDP 500 according to this embodiment, since an upper portion of the discharge space 520 where a discharge occurs is narrower than a lower portion thereof, concentration of plasma due to dispersion of a discharge is easily achieved, thereby advantageously increasing the luminous efficiency of the PDP 500.

The other portions, although not specified herein, are substantially the same as those shown in the first embodiment.

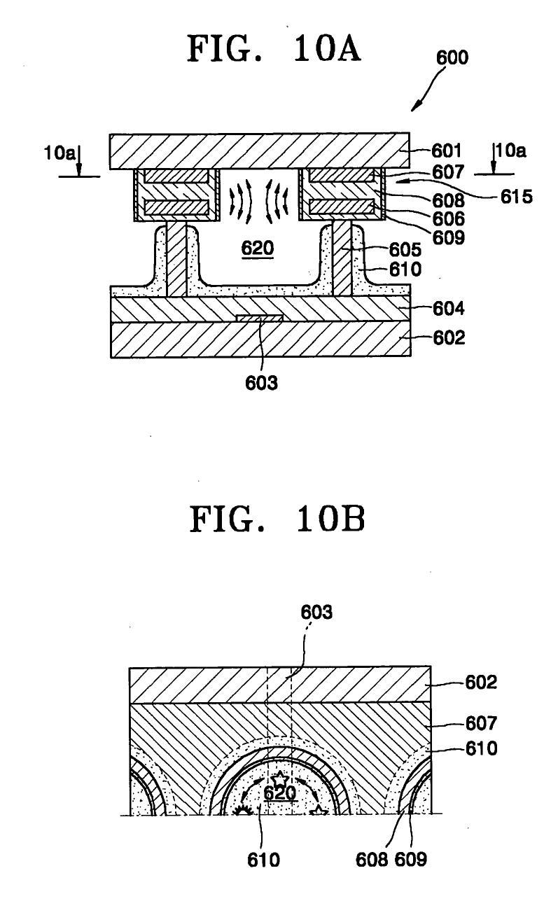

FIGS. 10A and 10B show a discharge space 620 of a PDP 600 according to a third embodiment of the present invention. Referring to FIGS. 10A and 10B, the discharge space 620 of the PDP according to the third embodiment of the present invention is substantially the same structure as that of the discharge space 520 of the PDP according to the second embodiment of the present invention with the exception of a side wall 615 being circular rather than rectangular. In the PDP 600 according to the third embodiment, concentration of plasma is much more easily achieved.

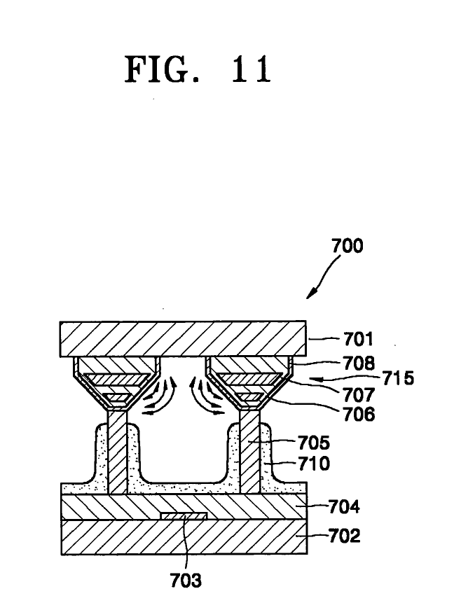

FIG. 11 shows a discharge space 720 of a PDP 700 according to a fourth embodiment of the present invention. Referring to FIG. 11, the discharge space 720 of the PDP according to the fourth embodiment of the present invention is substantially the same structure as that of the discharge space 520 of the PDP according to the second embodiment of the present invention with the exception of a discharge surface of a side wall 715 being tilted with respect to a substrate, rather than being perpendicular to the substrate. In the PDP 700 according to the fourth embodiment, concentration of plasma and dispersion of plasma to the central portion of the discharge space 720 are much more easily achieved.

The PDPs according to the above-described embodiments and the PDP according to an aspect of the present invention can be employed in a flat display device, e.g., a plasma display device, according to an aspect of the present invention.

The PDP according to the present invention and the flat display device comprising the PDP, have various advantages, including the following.

First, an aperture percentage and visible light transmissivity of a front substrate are remarkably improved. In the PDP according to the present invention, since visible light emitted from a discharge space passes through the front substrate and there is no element in the front substrate which can adversely affect the transmittance of visible light, such as discharge electrodes, a dielectric layer or a protective layer, the aperture percentage can be greatly increased, and the transmissivity is also increased to approximately 90%, comparably higher than the conventional PDP transmissivity of 60% or less.

Second, a discharge surface can be greatly increased. In the PDP according to the present invention, discharge occurs at all sides where discharge spaces are formed, thereby increasing the discharge surface to approximately four or more times that of the conventional PDP.

Third, discharge sections can be greatly increased. In the PDP according to the present invention, a discharge occurs at sides where a discharge space is formed and is then dispersed to the central portion of the discharge space. Thus, the discharge sections are noticeably increased compared to the conventional PDP, thereby efficiently utilizing the overall discharge space.

Fourth, the volume and quantity of plasma generated can be greatly increased. In the PDP according to the present invention, since a discharge occurs at sides where a discharge space is formed and is then dispersed to the central portion of the discharge space, the volume of plasma generated by a discharge is noticeably increased and the amount thereof is also greatly increased, thereby emitting more ultraviolet rays due to the increased plasma.

Fifth, plasma can be easily concentrated on the central portion of a discharge space. In the PDP according to the present invention, a discharge occurs at sides where a discharge space is formed and is then dispersed to the central portion of the discharge space, and the plasma is concentrated on the central portion of the discharge space accordingly. Also, the plasma tends to be concentrated on the central portion of the discharge space due to an electric field caused by voltages applied to the discharge electrodes formed on the lateral surfaces the discharge space, thereby utilizing space charges during discharge.

Sixth, the luminous efficiency can be greatly improved. In the PDP according to the present invention, since a great amount of visible light is emitted and since a space discharge can be utilized in causing a discharge, a low voltage drive is possible, thereby remarkably enhancing the luminous efficiency.

Seventh, the luminous efficiency can be enhanced even by using an Xe discharge gas. Using a high-density Xe discharge gas for the purpose of increasing the luminous efficiency usually makes a low voltage drive difficult. In the PDP according to the present invention, a discharge surface is enlarged and the discharge sections are increased, so that the amount of plasma produced is increased, thereby allowing a low voltage drive. Thus, even when the high-density Xe discharge gas is used, a low voltage drive is still possible, thereby improving the luminous efficiency.

Eighth, the discharge response speed is high and a fast drive is possible. In the PDP according to the present invention, since discharge electrodes are arranged on lateral surfaces of a discharge space rather than on a front substrate through which visible light passes, that is, since the transmittance of visible light is not interfered with by any element formed on the front substrate, a transparent electrode having a large resistance is not needed as a discharge electrode, but rather a metal electrode having low resistance can be used as the discharge electrode. Thus, the discharge response speed becomes fast, thereby enabling a fast drive of the PDP without waveform distortion.

Ninth, the occurrence of a permanent latent image phenomenon can be prevented. In the PDP according to the present invention, the electric field caused by voltages applied to the discharge electrodes formed on the lateral surfaces the discharge space brings about a concentration of plasma on the central portion of the discharge space. Thus, even if a discharge occurs for a prolonged period of time, ions produced by the discharge can be prevented from colliding with the fluorescent substance due to the electric field, thereby preventing the permanent latent image phenomenon from occurring due to the fluorescent substance being damaged by ion sputtering. Particularly, in earlier PDPs in which a high-density Xe discharge gas is used, the occurrence of the permanent latent image phenomenon is an extremely serious problem. According to the present invention, the permanent latent image can be prevented.

While the present invention has been described in connection with specific embodiments thereof, it is capable of various changes and modifications without departing from the spirit and scope of the invention. It should be appreciated that the scope of the invention is not limited to the detailed description of the invention herein above, which is intended merely to be illustrative, but rather compresses the subject matter defined by the following claims.

1. A plasma display panel comprising:
a pair of substrates spaced apart from each other and facing each other;
a phosphor arranged between the pair of substrates in a predetermined pattern; and
an electrode layer adapted to apply the same potential on a plane arranged between the pair of substrates at a predetermined angle with respect to a direction perpendicular to the pair of substrates.

2. The plasma display panel of claim 1, wherein the electrode layer includes an internal space where a discharge occurs.

3. The plasma display panel of claim 1, wherein the electrode layer encloses an internal space where a discharge occurs.

4. The plasma display panel of claim 1, wherein the electrode layer is annular.

5. The plasma display panel of claim 1, wherein the electrode layer is arranged on a surface in a direction perpendicular to the pair of substrates.

6. The plasma display panel of claim 1, further comprising another electrode layer spaced a predetermined distance apart from the electrode layer.

7. A plasma display panel comprising:
a pair of substrates having a plurality of discharge spaces arranged between facing surfaces thereof;
a phosphor arranged between the pair of substrates in a predetermined pattern;
one or more sustain electrodes arranged on a surface having a predetermined angle with respect to a direction perpendicular to the pair of substrates and adapted to sustain a discharge by applying an AC voltage thereto; and
an electrode adapted to initiate a discharge in response to a voltage applied thereto and to one of the one or more sustain electrodes.

8. The plasma display panel of claim 7, wherein the electrode includes an internal space where a discharge occurs.

9. The plasma display panel of claim 7, wherein the electrode encloses an internal space where a discharge occurs.

10. The plasma display panel of claim 7, wherein the electrode is annular.

11. A plasma display panel comprising:
a pair of substrates having a plurality of discharge spaces arranged between facing surfaces thereof; and
at least one electrode arranged to enclose the discharge spaces and adapted to sustain a discharge on surfaces forming the discharge spaces, excluding facing surfaces of the pair of substrates, by applying an AC voltage thereto.

12. The plasma display panel of claim 11, wherein the at least one electrode is arranged between the pair of substrates.

13. The plasma display panel of claim 11, wherein the at least one electrode is arranged perpendicular to the pair of substrates.

14. The plasma display panel of claim 11, wherein the at least one electrode is arranged at an angle with respect to the pair of substrates.

15. The plasma display panel of claim 11, wherein the at least one electrode is arranged parallel to the pair of substrates.

16. The plasma display panel of claim 11, wherein the at least one electrode is arranged to extend from the pair of substrates toward a central portion of the discharge space.

17. A plasma display panel comprising:
a pair of substrates spaced apart from each other and facing each other;
a side wall dividing a space between the pair of substrates into a plurality of discharge spaces; and
at least one electrode adapted to sustain a discharge on surfaces forming the plurality of discharge spaces, excluding facing surfaces of the pair of substrates.

18. The plasma display panel of claim 17, wherein the at least one electrode is arranged on the side wall.

19. The plasma display panel of claim 17, wherein the at least one electrode is arranged substantially parallel to the side wall.

20. The plasma display panel of claim 17, wherein the at least one electrode is arranged at an angle with respect to the pair of substrates.

21. The plasma display panel of claim 17, wherein the at least one electrode is arranged to enclose the plurality of discharge spaces.

22. A plasma display panel comprising:
a pair of substrates having a plurality of discharge spaces between facing surfaces thereof; and
at least two electrodes adapted to sustain a discharge by applying an AC voltage thereto, the at least two electrodes arranged within the discharge space on two different surfaces meeting an axis perpendicular to the pair of substrates.

23. The plasma display panel of claim 22, wherein the at least two electrodes are arranged perpendicular to the pair of substrates.

24. The plasma display panel of claim 22, wherein the at least two electrodes are arranged at an angle with respect to the pair of substrates.

25. The plasma display panel of claim 22, wherein the at least two electrodes are arranged to enclose the plurality of discharge spaces.

26. A plasma display panel comprising:
a pair of substrates spaced apart from and facing each other; and
a surface adapted to sustain a discharge on a plurality of discharge spaces formed between the pair of substrates;
wherein the surface is arranged at an angle with respect to the pair of substrates.

27. The plasma display panel of claim 26, wherein a surface where a discharge is induced comprises a lateral surface of the discharge space.

28. The plasma display panel of claim 26, wherein the surface is arranged to enclose the discharge space.

29. The plasma display panel of claim 26, wherein a surface where a discharge is induced comprises a surface arranged perpendicular to the pair of substrates.

30. The plasma display panel of claim 26, wherein a surface where a discharge is induced comprises a surface arranged at an angle with respect to the pair of substrates.

31. The plasma display panel of claim 26, wherein a surface where a discharge is induced comprises a surface parallel to the pair of substrates.

32. The plasma display panel of claim 26, wherein a surface where a discharge is induced comprises a ring-shaped element surrounding an axis perpendicular to the pair of substrates.

33. A plasma display panel comprising:
a pair of substrates spaced a predetermined distance apart from each other and facing each other;
a side wall dividing a space between the pair of substrates into a plurality of discharge spaces;
at least one electrode arranged on the side wall and adapted to sustain a discharge by applying an AC voltage thereto; and
a phosphor adapted to generate visible light in the discharge space.

34. The plasma display panel of claim 33, wherein the at least one electrode is arranged to enclose the plurality of discharge spaces.

35. A plasma display panel comprising:
a pair of substrates having a plurality of discharge spaces between facing surfaces thereof;
a side wall dividing a space between the pair of substrates into a plurality of discharge spaces;
one or more discharge electrodes arranged on the side wall and adapted to sustain a discharge; and
at least one address electrode adapted to initiate a discharge in response to a voltage applied thereto and to one of the one or more discharge electrodes.

36. The plasma display panel of claim 35, wherein the at least one address electrode is arranged on one of the pair of substrates.

37. The plasma display panel of claim 35, further comprising a phosphor arranged on the substrate where the at least one address electrode is not arranged, the phosphor adapted to generate visible light in the discharge space.

38. The plasma display panel of claim 35, wherein the at least one address electrode is arranged on the side wall.

39. The plasma display panel of claim 38, further comprising a phosphor arranged on one of the pair of substrates and adapted to generate visible light in the discharge space.

40. The plasma display panel of claim 35, wherein the one or more discharge electrodes are arranged to enclose the plurality of discharge spaces.

41. A plasma display panel comprising:
a plurality of discharge spaces arranged between facing surfaces of a pair of substrates;
at least one electrode layer arranged between the facing surfaces of the pair of substrates to enclose each of the plurality of discharge spaces;
wherein the at least one electrode layer is adapted to selectively produce an electric field in at least one of the plurality of discharge spaces to sustain a discharge therein.

42. The plasma display panel of claim 41, further comprising a phosphor arranged in each of the plurality of discharge spaces and adapted to generate visible light in response to the electric field produced by the at least one electrode layer.

43. The plasma display panel of claim 41, wherein the electric field produced by the at least one electrode layer in at least one of the plurality of discharge spaces disburses the discharge throughout each discharge space.

44. The plasma display panel of claim 42, wherein the electric field produced by the at least one electrode layer in at least one of the plurality of discharge spaces is arranged away from the phosphor to extend the lifetime thereof.

45. The plasma display panel of claim 43, further comprising a phosphor arranged in each of the plurality of discharge spaces and adapted to generate visible light in response to the electric field produced by the at least one electrode layer.

46. The plasma display panel of claim 45, wherein the electric field produced by the at least one electrode layer in at least one of the plurality of discharge spaces is arranged away from the phosphor to extend the lifetime thereof.
